(19) United States
(12) Patent Application Publication
(10) Pub. No.: US 2023/0188090 A1
(43) Pub. Date: Jun. 15, 2023

(54) METHOD AND DEVICE OF OPERATING DIAGNOSIS OF A PHOTOVOLTAIC CHAIN COMPRISING AT LEAST ONE PHOTOVOLTAIC MODULE

(71) Applicant: Commissariat à l'énergie atomique et aux énergies alternatives, Paris (FR)

(72) Inventors: Sylvain LESPINATS, Grenoble Cedex 9 (FR); Arnaud REVEL, Grenoble Cedex 9 (FR); Alexandre PLISSONNIER, Grenoble Cedex 9 (FR)

(73) Assignee: Commissariat à l'énergie atomique et aux énergies alternatives, Paris (FR)

(21) Appl. No.: 18/064,410

(22) Filed: Dec. 12, 2022

(30) Foreign Application Priority Data
Dec. 14, 2021 (FR) 21 13506

(51) Int. Cl. H02S 50/10

(52) U.S. Cl. CPC H02S 50/10

(57) ABSTRACT

The invention relates to a method and device for diagnosing the operation of a photovoltaic module string. The method involves acquiring a series of current and voltage measurements forming a current versus voltage curve, known as the I(V) curve, and the steps of:
transforming (46) into polar coordinates, each pair of current and voltage values of the I(V) curve,
calculating (48-54) parameters of a first electrical model and second electrical model each approximating said I(V) curve, as well as a first cost representative of a deviation between said first model and said I(V) curve, and a second cost representative of a deviation between said second model and said I(V) curve, using a distance metric in the polar coordinate space,
selecting (56) an electrical estimation model for estimating the I(V) curve and diagnosing (58) operation based on this selected electrical estimation model.

This application claims priority to French Patent Application No. FR 21 13506 filed Dec. 14, 2021 the entire disclosure of which is incorporated by reference herein.

### FIELD OF THE INVENTION

The present invention relates to a method and device for diagnosing the operation of a photovoltaic module string comprising at least one photovoltaic module.

The invention is in the field of electricity production by photovoltaic installations, and more particularly in the field of monitoring the correct operation of such installations.

### BACKGROUND OF THE INVENTION

In a known manner, photovoltaic installations comprise one or more strings of photovoltaic modules, each string comprising a set of photovoltaic modules, which may be reduced to a single photovoltaic module, the strings being connected in series and/or in parallel between a positive terminal and a negative terminal, each module being composed of at least one photovoltaic cell, generally an array of cells, each cell being a unit configured to produce an electric current from light energy. Such an installation is adapted to supply electrical power to a load, for example an inverter adapted to generate AC voltages and currents from a DC power source, connected to an AC power grid.

One of the problems that arises in this type of installation is the monitoring of the correct functioning of the installation, and also the diagnosis in case of detection of a malfunction.

Indeed, a drop in the supply of electrical energy may be caused by the presence of shading, for example, which may affect a subset of the photovoltaic modules, or by other problems requiring maintenance, such as dirt, a lack of transparency of the glass, or ageing of the connectors.

Methods are known for diagnosing the operation of strings of photovoltaic modules on the basis of current and voltage measurements taken on the site of the installation during a measurement period, forming a curve (or characteristic) of current versus voltage, traditionally known as the I(V) curve. For a photovoltaic module, it has been proposed to model the I(V) curve by a single-diode electrical circuit operating model, characterised by values of series resistance, parallel resistance, short-circuit current I_{sc}, open circuit voltage V_{oc}, diode ideality factor. The analysis of these modelling values provides diagnostic information on the operation.

In addition, it has also been shown that in the case of shading or any other situation where a subset of PV modules delivers less electricity (in proportion to its size) than the rest of the installation (e.g. subset of modules with dirt or other defects), the single-diode electrical circuit model is not adequate, the current-voltage characteristic curve shows an inflection.

Patent FIR 18 60499 describes a method for diagnosing a photovoltaic module string, making it possible to automatically detect a fault inducing an inflection of the I(V) curve by means of an electrical model known as the bypass model. The method described in this patent comprises:
detection of a first linear area and a second linear area of the I(V) characteristic,
determination of the parameters of a first electrical model without bypass corresponding to the measured I(V) characteristic,
determination of the parameters of a second electrical model with bypass corresponding to the measured I(V) characteristic,
determination of the best model for modelling the measured I(V) characteristic between the model without bypass and the model with bypass.

The method proposed in this patent has the advantage of allowing both the detection of the possible presence of a “bypass” type malfunction (i.e. shading or other mismatch-inducing fault), and the calculation of electrical model parameters to diagnose other possible malfunctions requiring maintenance.

However, as noted in this patent, the electrical models are complex: the first electrical model without a bypass is transcendental (i.e. it does not allow for analytical solutions) and consists of a linear and an exponential part. This makes it difficult to accurately and quickly quantify a deviation or distance between a model and the measured I(V) characteristic.

In addition, the ends of the curve are difficult to estimate due to either a lack of current/voltage measurement data or too much accumulation of current/voltage measurement data, which leads to noise. In both of these cases, calculation inaccuracies are noted.

Therefore, there is a need to improve the accuracy and noise robustness of the modelling of observed measurements in order to improve the diagnosis of operation.

### SUMMARY OF THE INVENTION

To this end, the invention proposes, according to one aspect, a method for diagnosing the operation of a string of photovoltaic modules comprising at least one photovoltaic module, the method comprising an acquisition of a series of current and voltage measurements measured during a monitoring period, forming a curve of current as a function of voltage, called the I(V) curve. The method comprises the steps, implemented by a computing processor, of:

transforming into polar coordinates, each pair of current and voltage values of the I(V) curve being transformed into a corresponding radius-angle pair,

calculating parameters of a first electrical model approximating said I(V) curve, and a first cost representative of a deviation between said first model and said I(V) curve, by implementing a distance metric in polar coordinate space,

calculating parameters of a second electrical model approximating said I(V) curve, and a second cost representative of a deviation between said second model and said I(V) curve, by implementing a distance metric in polar coordinate space,

selecting an electrical model for estimating the I(V) curve from said first electrical approximation model and second electrical approximation model according to the first and second costs,

diagnosing operation as a function of the value of at least one parameter of the selected electrical estimation model.

Advantageously, the proposed method makes it possible, thanks to the use of polar coordinates, to remedy the aforementioned disadvantages of the prior art, and to allow a comparison between electrical models and measurement data, whatever part of the I(V) curve is being considered.

The method of diagnosing operation according to the invention may have one or more of the following features, taken independently or in any acceptable combination.

The method further comprises a step of estimating a short-circuit current value and an open-circuit voltage value before the transformation into polar coordinates, corresponding respectively to extreme points of the I(V) curve, which are respectively a first point of voltage equal to zero and current equal to the short-circuit current value (I_{sc}) and a second point of voltage equal to the open circuit voltage value (V_{oc}) and current equal to zero, and wherein the polar coordinate transformation is normalised by said short circuit current (I_{sc}) and open circuit voltage values.

The transformation into normalized polar coordinates comprises, for each pair of current and voltage values, a division of the current value by said short circuit current value, and of the voltage value by said open circuit voltage value.

For a pair of measured values of current Iⱼ and voltage Vⱼ, the transformation into polar coordinates implements the following calculation to obtain a radius ρᵢ and a corresponding angle φᵢ:

$${ρ}_{j} = \sqrt{{( \frac{{I}_{j}}{{I}_{sc}} )}^{2} + {( \frac{{V}_{j}}{{V}_{oc}} )}^{2}} and {φ}_{j} = Arctan ( \frac{{I}_{j} \times {V}_{oc}}{{V}_{j} \times {I}_{sc}} )$$

The estimating of a short-circuit current value comprises:

calculating a power versus voltage characteristic from the current and voltage measurements,

modelling, in a first linear region of the power versus voltage characteristic, the power versus voltage characteristic by a first linear or polynomial power model, the short circuit current value being estimated by the zero derivative of said first power model.

The estimating of an open circuit voltage value comprises:

calculating a power versus current characteristic from the current and voltage measurements,

modelling, in a second linear region of the power versus voltage characteristic, the power versus current characteristic by a second linear or polynomial power model, the open circuit voltage value being estimated by the zero derivative of said second power model.

The first electrical model for approximating said I(V) curve is a so-called single-diode electrical model, defined by the following equation in polar coordinate space:

$${I}_{p h} + {I}_{o} - ρ ( φ ) \times \frac{cos ( φ ) + ( {R}_{s} + {R}_{p} ) \times sin ( φ )}{{R}_{p}} - {I}_{0} \times {e}^{ρ ( φ ) \times \frac{cos ( φ ) + {R}_{s} \times sin ( φ )}{N}} = 0$$

Where ρ(φ) is the radius corresponding to the angle φ according to the first approximation model, Iₚₕ, I₀, Rₛ, Rₚ and N are parameters of said first electrical model. The method further comprises determining a monitoring period duration for the acquisition of the current and voltage measurements, based on a previously stored table of monitoring period durations depending on physical characteristics of the photovoltaic module string comprising at least one photovoltaic module to be monitored.

The method further comprises displaying a diagnostic result on a human-machine interface, indicating a state of good working order or a presence of an anomaly in the operation of said at least one photovoltaic module.

According to another aspect, the invention relates to a device for diagnosing the operation of a string of photovoltaic modules comprising at least one photovoltaic module, adapted to obtain, from an acquisition module, a series of current and voltage measurements measured during a monitoring period, forming a curve of current as a function of voltage, called the I(V) curve. The device comprises a computational processor configured to implement:

a module for transforming into polar coordinates, each pair of current and voltage values of the I(V) curve being transformed into a corresponding radius-angle pair,

a module for calculating parameters of a first electrical model approximating said I(V) curve, and a first cost representative of a deviation between said first model and said I(V) curve, by implementing a distance metric in polar coordinate space,

a module for calculating parameters of a second electrical model approximating said I(V) curve, and a second cost representative of a deviation between said second model and said I(V) curve, by implementing a distance metric in polar coordinate space,

a module for selecting an electrical model for estimating the I(V) curve from said first electrical approximation model and second electrical approximation model according to the first and second costs,

a module for diagnosing operation as a function of the value of at least one parameter of the selected electrical estimation model.

The device further comprises a module for estimating a short circuit current value I_{sc} and an open circuit voltage value V_{oc} from the acquired current and voltage values.

The device is configured to implement the method for diagnosing the operation of a photovoltaic module string comprising at least one photovoltaic module, in all its variants.

According to another aspect, the invention relates to a system for diagnosing operation comprising at least one photovoltaic module, comprising a module for acquiring values of a series of current and voltage measurements measured during a monitoring period of at least one photovoltaic module of said photovoltaic module string, and a device for diagnosing operation as briefly described above.

According to another aspect, the invention relates to a computer program comprising software instructions, which, when implemented by a programmable electronic computer, implement a method for diagnosing operation as defined above.

### BRIEF DESCRIPTION OF THE DRAWINGS

Further features and advantages of the invention will become apparent from the detailed description given below, by way of indication and not in any way limiting, with reference to the appended figures, in which:

FIG. 1 is a schematic representation of a photovoltaic module string to which the method for diagnosing operation is applicable;

FIG. 2 is an example of an I(V) curve and the first model for estimating the I(V) curve in the current/voltage reference frame;

FIG. 3 is an electrical diagram of a single-diode circuit of an equivalent electrical model of a photovoltaic module string;

FIG. 4 is a flowchart of the main steps of a method for diagnosing operation according to one embodiment;

FIG. 5 is an example of a power versus voltage characteristic and a linear model to estimate the short circuit current I_{sc};

FIG. 6 is an example of an I(V) curve with inflection and a second model for estimating the I(V) curve, in the resence of a fault generating a mismatch;

FIG. 7 shows the example in FIG. 6 in polar coordinate space;

FIG. 8 is a block diagram of an embodiment of the short circuit current value estimation and the open circuit voltage value estimation.

### DETAILED DESCRIPTION OF EMBODIMENTS

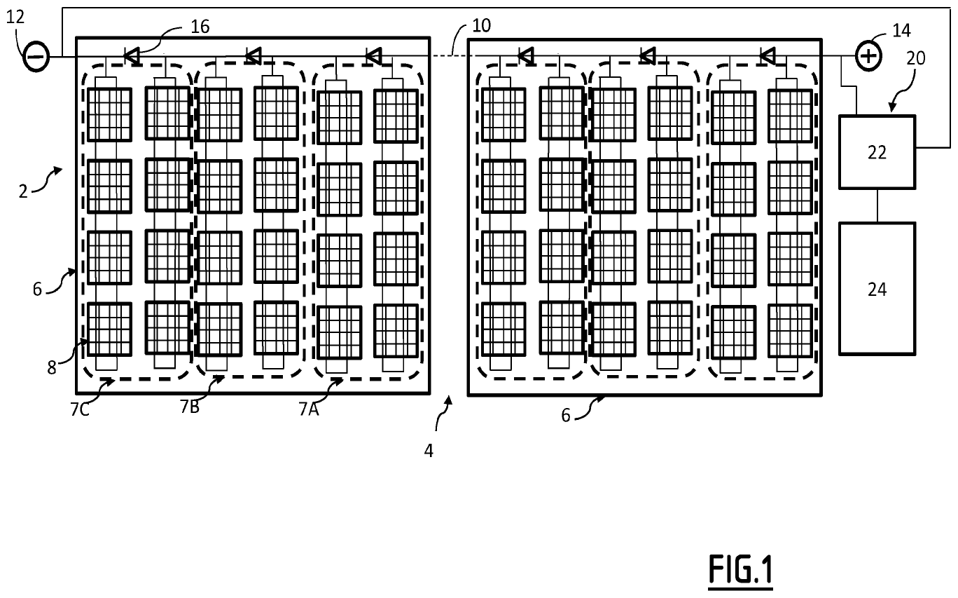

FIG. 1 schematically illustrates a photovoltaic installation 2, comprising a string 4 of photovoltaic modules 6, each module being composed of a plurality of photovoltaic cells 8, for example a number Q of photovoltaic cells, Q being greater than or equal to 1, and preferably between 60 and 72

Photovoltaic cells are known per se and are not described in detail here.

The photovoltaic modules 6 are connected in series or parallel to a conductor 10, the positive 14 and negative 12 terminals of which are connected to a load, not shown.

In a known way, the installation 2 is adapted to supply electricity to the load.

Each photovoltaic module 6 has a number of cell strings 7A, 7B, 7C, which are connected via diodes 16, known as bypass diodes, forming a system for disconnecting and reconnecting one or more cell strings of each photovoltaic module in this example.

Of course, this is an example, as any photovoltaic installation architecture is applicable for a diagnosis of operation.

In addition, the representation in FIG. 1 schematically illustrates a number of diodes 16, it being understood that other embodiments of connection and disconnection switches are applicable.

In one embodiment, a photovoltaic string reconnection system as described in patent application FR3074611 A1 is used.

The system illustrated in FIG. 1 further comprises an operation-diagnosing system 20, comprising a module 22 for acquiring values of a series of measurements of current I and voltage V measured during a monitoring period of at least one photovoltaic module of the installation 2, and a device 24 for diagnosing operation 20.

The device 24 for diagnosing operation, which will be described in more detail below, is a programmable electronic device, comprising a processor or microcontroller, and configured to implement calculations. This device is placed either on the site of the photovoltaic installation or remotely, for example in a control centre, in which case it includes means of communication with the module 22 for acquiring the values of a series of measurements of current I and voltage V.

The acquisition module 22 provides series of current and voltage values at successive points in time during a monitoring period of the string of photovoltaic modules comprising at least one photovoltaic module, or of the set of strings that forms the element of the installation to which the diagnosis of operation is applied.

The measured current and voltage values are stored, for example, in a memory of the function diagnostics system.

These values form a current versus voltage curve, or I(V) curve, also called the I(V) characteristic. Each pair of values of current Iⱼ and voltage Vⱼ measured at a time tⱼ of the monitoring period form a point of the I(V) curve, which can be represented in a Cartesian reference frame in which the ordinate axis represents the current (I axis) and the abscissa axis represents the voltage (V axis).

In the following, the terms characteristic I(V) and I(V) curve may be used interchangeably.

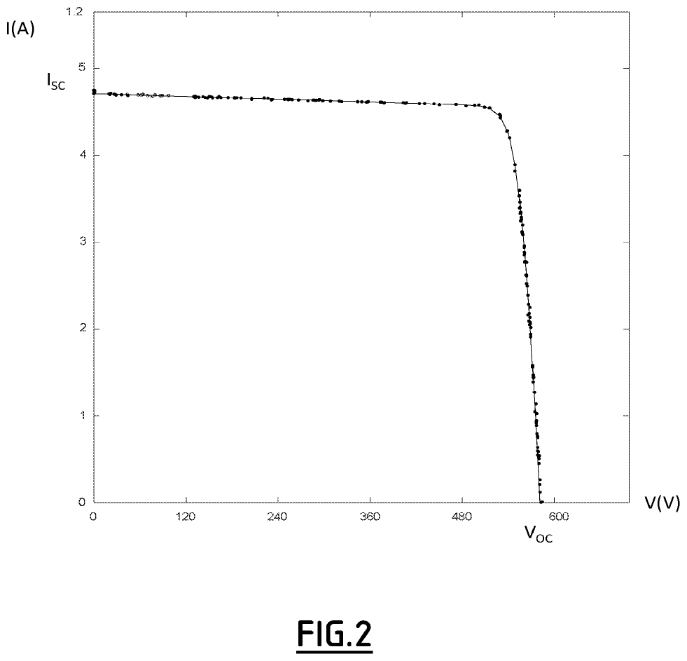

FIG. 2 shows an example of points on an I(V) curve in the Cartesian current/voltage reference frame as described above, and an electrical model for estimating the I(V) curve. The current is in Amps, and the voltage in Volts.

The measurement points (I(V) curve) are shown as dots, and an electrical model for estimating the I(V) curve is shown as a solid line.

In addition, the short circuit current value I_{sc} and the open circuit voltage value V_{oc} are shown in FIG. 2. The short-circuit current value I_{sc} is the current value at V=0, or in other words the intersection of the I(V) curve with the ordinate axis, and the open-circuit voltage value V_{oc} is the voltage value corresponding to I=0, or in other words the intersection of the I(V) curve with the abscissa axis.

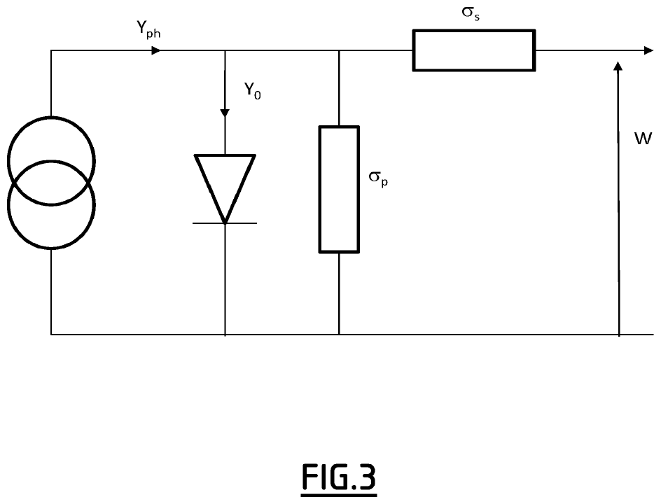

The I(V) curve is modelled by an electrical model which is, for example, a single-diode electrical model, a circuit diagram of which is shown in FIG. 3.

The single-diode model is an advantageous model for modelling an I(V) curve of a photovoltaic module, as it is relatively simple, being defined by a small set of parameters.

Such a model is provided here by way of example, it being understood that the invention applies analogously with other applicable models for modelling an I(V) curve of operation of a photovoltaic module in an operating mode.

The single-diode model is defined by a series resistance σₛ, a parallel resistance σ_{ρ}, the photocurrent Yₚₕ, the dark current of the diode Y₀ and an ideality factor of the diode.

In its application to define an approximation model of a photovoltaic module I(V) curve, the single-diode model is written:

$$Y = {Y}_{p h} - \frac{W + {σ}_{s} \times Y}{{σ}_{p}} - {Y}_{0} \times ( {e}^{\frac{W + {σ}_{s} \times Y}{M}} - 1 ) \qquad [ MATH 1 ]$$

Where Y is the current, W is the voltage according to the model, and M is a constant depending on the number of photovoltaic cells in the photovoltaic installation element to which the model is applied, the ideality of the diode, and the temperature of the photovoltaic cells.

It should be noted that it is possible to derive a model equivalent to that formulated by equation [MATH 1] which expresses the voltage W as a function of the current Y and voltage W.

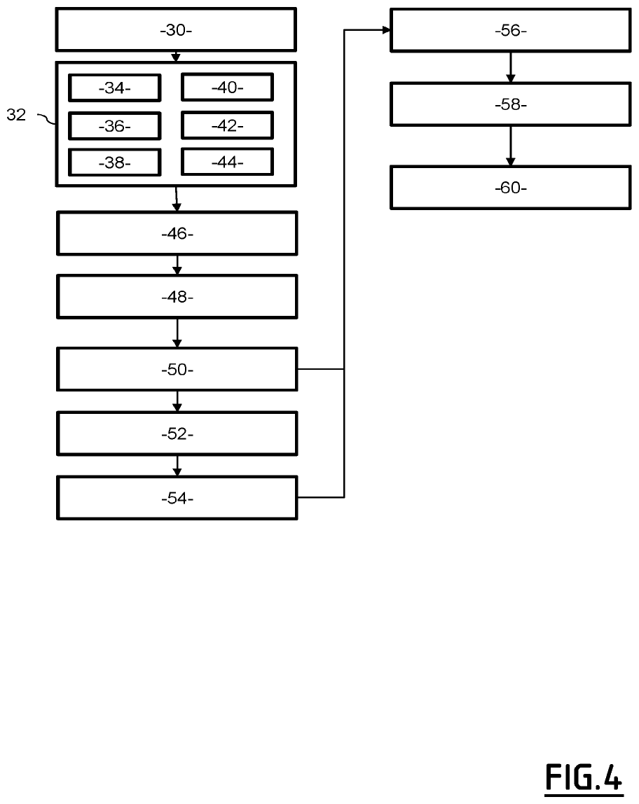

FIG. 4 is a flowchart of the main steps of a method for diagnosing the operation of a photovoltaic module string comprising at least one photovoltaic module according to one embodiment.

This method is implemented automatically by a computational processor of a device 24 for diagnosing operation, which is a programmable electronic device.

This method comprises a step 30 of acquiring a series of current and voltage measurements measured during a monitoring period of the string comprising at least one photovoltaic module.

In one embodiment, in step 30 pairs of measured current and voltage values (Iⱼ, Vⱼ) are received, the actual measurement being performed by a module 22 which transmits these values to the device 24 for diagnosing operation. These measured values form an I(V) curve (current versus voltage curve) of the monitored photovoltaic module string.

The measurements are acquired after at least one monitored photovoltaic module has been disconnected from the system during the monitoring period.

The monitoring period is on the order of a few milliseconds (typically between 5 and 100 milliseconds).

Preferably, the duration of the monitoring period is chosen to optimise the I(V) versus irradiance plot when an irradiance measurement is available.

Alternatively, the monitoring period is started from the detection of the current value

Iₘₚₚ at the maximum power point.

In one embodiment, for each of the cases, a previously stored table of monitoring period durations, depending on the electronic components of the monitored photovoltaic module(s), indicates a monitoring duration. Thus, the acquisition of measurements to plot the I(V) curve is optimised.

Alternatively, the I(V) curve of the at least one photovoltaic module is stored and then retrieved from a memory of the operation diagnostic device 24.

The method further comprises a step 32 of estimating a short circuit current value I_{sc} and an open circuit voltage value V_{oc} from the current and voltage values acquired in step 30.

In practice, the I_{sc} and V₀ values are difficult to determine accurately because many measurement points are acquired when at least one monitored PV module is in the corresponding operating areas. The acquired measurements are noisy.

According to one embodiment, step 32 comprises sub-steps, respectively, for estimating the short circuit current I_{sc}:

a sub-step 34 of calculating a power characteristic P(V) as a function of voltage, from current and voltage measurements, and

a sub-step 36 of modelling the power characteristic as a function of the voltage P(V) by a model p(V), called the first power model, which is a linear or polynomial model.

Then, the short-circuit current I_{sc} is estimated in sub-step 38 by the zero derivative of the first power model p(V):

$${I}_{sc} = \frac{dp ( V )}{dV} ( V = 0 ) \qquad [ MATH 2 ]$$

Step 32 further comprises the following sub-steps for estimating the open circuit voltage:

sub-step 40 for calculating a power versus current characteristic P(I) from the current and voltage versus current measurements,

sub-step 42 of modelling the power characteristic as a function of the current P(I) by a linear or polynomial model p(I), the so-called second power model.

Then, the open circuit voltage V is estimated in sub-step 44 by the zero derivative of the second power model p(I):

$${V}_{oc} = \frac{dp ( I )}{dI} ( I = 0 ) \qquad [ MATH 3 ]$$

In one variant, steps 34 and 40 are merged, with a power calculation Pⱼ being performed for each pair of measurements (Iⱼ,Pⱼ) by Pⱼ=IⱼxVⱼ, and the respective modelling by the first power versus voltage model p(V) and the second power versus current model p(I) are then performed.

In another variant, the power calculation is performed on the fly, with only the respective modelling of power versus voltage (or first power model) and power versus current (or second power model) being performed.

Preferably, the respective power modelling is performed for a subset of measurements (Iⱼ,Vⱼ), respectively for times in a first linear area of the power versus voltage characteristic, close to I_{sc}, on the one hand, and for times in a second linear area of the power versus current characteristic, close to V_{oc}, on the other hand.

A linear area (or linearity area) is defined here as an area in which the measurement points follow a substantially linear path.

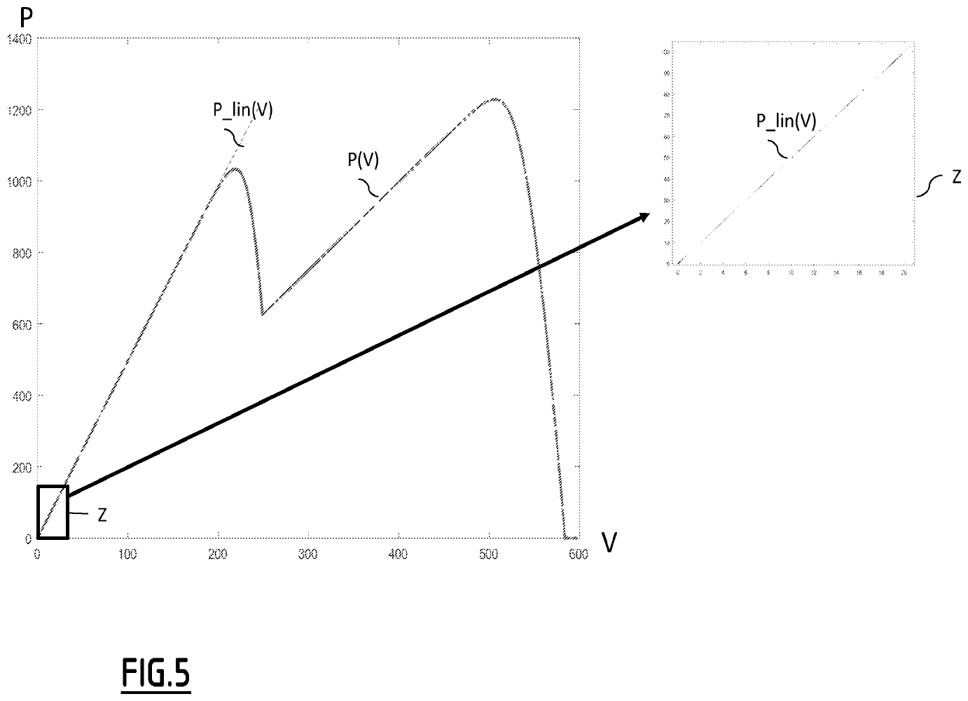

FIG. 5 shows a power versus voltage characteristic, P(V), calculated over all the measurements, with power plotted on the ordinate axis and voltage on the abscissa axis, a linear area Z, close to I_{sc}, in which the power characteristic is linear, and a linear modelling P_lin(V) from a subset of the calculated points. The detail of the operating area Z near I_{sc}, in which the power characteristic is linear, is shown on the right-hand side of the figure.

Advantageously, modelling the power as a function of voltage and/or as a function of current provides a more robust estimate of noise than an estimate by direct modelling of current as a function of voltage in the operating region near I_{sc}, or by direct modelling of voltage as a function of current in the operating region near V_{oc}.

The method further includes a step 46 of performing a polar coordinate transformation of the current and voltage normalized by the values of I_{sc} and V_{oc} respectively, so as to obtain a radius equal to 1 at the extreme points of the polar coordinate curve corresponding to the I(V) curve. In other words, after applying the normalized polar coordinate transformation, for angle values φ of 0 and π/2, the radius is equal to 1.

Thus, a pair of measured values of current Iⱼ and voltage Vⱼ is transformed into a pair of values of radius ρⱼ and corresponding angle φⱼ, the transformation into polar coordinates implementing the following calculation:

$${ρ}_{j} = \sqrt{{( \frac{{I}_{j}}{{I}_{sc}} )}^{2} + {( \frac{{V}_{j}}{{V}_{oc}} )}^{2}} and {φ}_{j} = Arctan ( \frac{{I}_{j} \times {V}_{oc}}{{V}_{j} \times {I}_{sc}} ) \qquad [ MATH 4 ]$$

Advantageously, the transformation into polar coordinates makes it possible to better model the measurements acquired, by a first model of the type of electrical model with a diode as described above, and by a second model with a bypass (or with inflection).

Indeed, in the current-voltage reference frame (Cartesian coordinates of the I(V) curve), for a single-diode electrical model approximation, the presence of linear and exponential components of the model makes the evaluation of the distance between the model and the measurement points by a classical distance (e.g. Euclidean distance) inadequate, because an equivalent deviation on the voltage (for example) can have a very different impact on the distance depending on its location on the curve.

The method further comprises a step 48 of calculating the parameters of a first electrical I(V) curve approximation model, and a step 50 of calculating a first cost representative of a deviation between this first model and the I(V) curve, using a distance metric (also referred to as simply a metric) in polar coordinate space.

For example, the distance metric applied is the Euclidean distance, i.e. the quadratic sum of the differences between the values (ρⱼ, φⱼ) and the corresponding points of the first approximation model in the polar coordinate space.

Of course, any distance metric can be used, e.g. distance L1 (sum of absolute values of differences) or a Pearson correlation distance.

In a preferred embodiment, the first approximating electrical model is the single-diode electrical model described with reference to FIG. 3, whose parameters are optimised to best represent, according to the chosen metric, the measurement points forming the I(V) curve.

The optimisation is performed in polar coordinates as detailed below.

In polar coordinates, the single-diode electrical model of the formula [MATH 1] is described by the following formula:

$${I}_{p h} + {I}_{0} - ρ ( φ ) \times \frac{cos ( φ ) + ( {R}_{s} + {R}_{p} ) \times sin ( φ )}{{R}_{p}} - {I}_{0} \times {e}^{ρ ( φ ) \times \frac{cos ( φ ) + {R}_{s} \times sin ( φ )}{N}} = 0 \qquad [ MATH 5 ]$$

Where ρ(φ) is the radius corresponding to the angle φ according to the first approximation model.

The model parameters of equation [MATH 5] are related to the model parameters defined by [MATH 1] as follows:

$$I = \frac{Y}{{I}_{sc}} ; V = \frac{W}{{V}_{oc}}$$

$${I}_{p h} = \frac{{Y}_{sc}}{{I}_{sc}} ; {I}_{0} = \frac{{Y}_{0}}{{I}_{sc}}$$

$${R}_{p} = {σ}_{p} \times \frac{{I}_{sc}}{{V}_{oc}}$$

$${R}_{s} = {σ}_{s} \times \frac{{I}_{sc}}{{V}_{oc}}$$

$$N = \frac{M}{{V}_{oc}}$$

Due to the applied normalization, moreover, the following relationship holds:

$$ρ ( 0 ) = ρ ( \frac{π}{2} ) = 1$$

The parameters of photo-current Iₚₕ and dark current I₀ can be calculated by the formulas:

$${I}_{p h} = \frac{{e}^{\frac{1}{N}} - {e}^{\frac{{R}_{s}}{N}} + ( {R}_{s} + {R}_{p} - 1 ) \times ( {e}^{\frac{1}{N}} - 1 )}{{R}_{p} \times ( {e}^{\frac{1}{N}} - {e}^{\frac{{R}_{s}}{N}} )} \qquad [ MATH 6 ]$$

$${I}_{0} = \frac{{R}_{s} + {R}_{p} - 1}{{R}_{p} \times ( {e}^{\frac{1}{N}} - {e}^{\frac{{R}_{s}}{N}} )} \qquad [ MATH 7 ]$$

Therefore, the values of the photo-current Iₚₕ and dark current lo parameters are dependent on Rₚ, Rₛ and N.

In step 48 of calculating the parameters of a first electrical model for approximating an I(V) curve, in polar coordinate space, the parameter values calculated are those values of Rₚ, Rₛ and N which minimise the distance, according to the chosen metric, between the points provided by the first model and the current-voltage measurements represented in polar coordinates.

In one embodiment, given here as a non-exhaustive example, Rₛ is in the range [0.01-0.95], and is set to 0.01, Rₚ is in the range [1.05-100] and is set to 100, N is in the range [0.01-0.3] and is set to 0.01.

After initialization, an optimization phase of the estimation of the parameter values, depending on the distance according to the chosen metric is implemented.

For example, a gradient descent optimisation algorithm is used, with a chosen number of iterations and an objective function that minimises, at each iteration, the distance in polar coordinates between the first electrical model for approximating the I(V) curve defined by the parameters estimated at that iteration and the current and voltage measurements of the I(V) curve.

The first cost representative of a deviation between the first model and the I(V) curve (in polar coordinates), obtained in the calculation step 50, is equal to the distance, after optimization of the model parameters (in other words, the minimum distance), according to the chosen metric, between the first electrical model and the points of the I(V) curve. When the chosen metric is the quadratic sum of differences in polar coordinate space, the first deviation between the first approximation model ρ_{mod1}(φ) and the set of measurement points (ρᵢ, φᵢ) comprising J points, is written:

$${D}_{1} = {\sum }_{j = 1}^{J} {( {ρ}_{mod 1} ( {φ}_{j} ) - {ρ}_{j} )}^{2} \qquad [ MATH 8 ]$$

The method further comprises steps 52 of calculating the parameters of a second electrical I(V) curve approximation model, and a step 54 of calculating a second cost representative of a deviation between the second model and the I(V) curve, using the distance metric in polar coordinate space.

The second model for approximating the I(V) curve is, in one embodiment, a single-diode electrical model with an inflection, also known as a “bypass” model.

For example, such a model is suitable when the monitored photovoltaic module or module string is partially shaded, which leads to a decrease of the electric current production in the shaded area. This type of phenomenon can also be encountered in any situation where a part of the chain isolated by bypass diodes operates in a sub-optimal way compared to the rest of the chain (partially failed modules, non-homogeneous dirtiness, etc.). Hereafter, this will be called a mismatch.

In a photovoltaic installation 2 as shown in FIG. 1, bypass diodes are activated in case of shading or other faults to disconnect the shaded part and prevent it from consuming the electrical energy produced by the rest of the installation.

Such a single-inflexion model is characterised by parameters A_{d} and Aₗ where A_{d} is representative of the percentage of bypass diodes activated, and Aₗ represents the short-circuit current loss induced on the subset of photovoltaic cells disconnected by the bypass diodes.

The second approximation model of the I(V) curve is obtained from a first approximation model, which in one embodiment is the single-diode electrical model without a bypass.

Considering a formulation of a single-diode electrical model expressing voltage as a function of current, noted here as Wₜₕ(Y) and called the theoretical single-diode model, the second approximation model can be formulated as:

$${W}_{mod 2} ( Y ) = ( 1 - {A}_{d} ) \times {W}_{th} ( Y ) + {A}_{d} \times {W}_{th} ( \frac{Y}{1 - {A}_{I}} ) \qquad [ MATH 9 ]$$

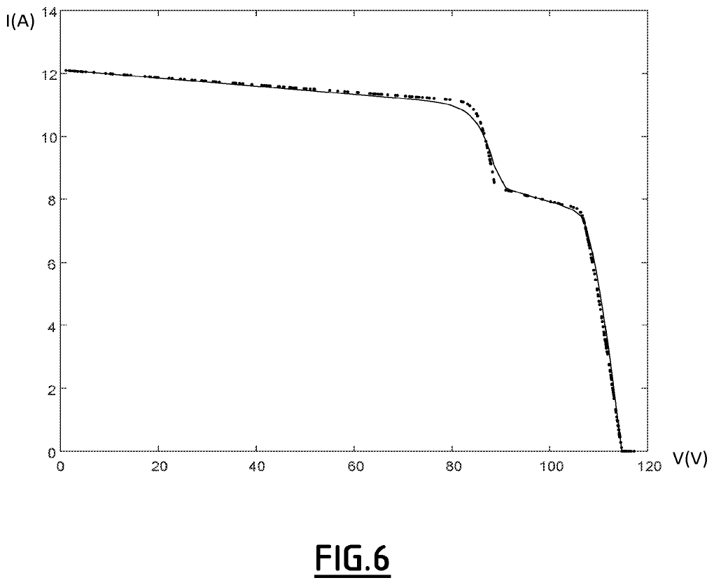

FIG. 6 shows an example of points on an I(V) curve in the Cartesian current/voltage reference frame in the case of the presence of a mismatch, and a second electrical model for estimating the I(V) curve associated with it. The current is in Amps, and the voltage in Volts.

The measurement points (I(V) curve) are shown as dots, and the second electrical model for estimating the I(V) curve is shown as a solid line. The figure shows the presence of an inflection.

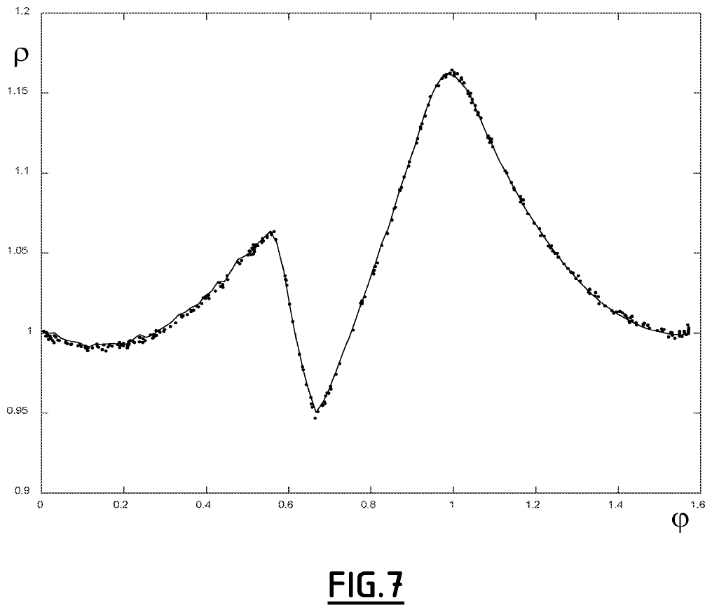

FIG. 7 shows an example of an I(V) curve with inflection applied in the polar coordinate system (ρ,φ), after transformation into polar coordinates has been applied to each point of the I(V) curve, and normalization has been applied so that the values of the radius at 0 and at π/2 are equal to 1.

In step 52, the estimation of the values of the parameters of the electrical model at a theoretical diode Wₜₕ is preferably made from a convex envelope formed from the points of the I(V) curve, and the estimation of the parameters A_{d}, Aₗ characterising the inflection is carried out in the space of the current/voltage measurements, in order to make the estimation of the initial parameters more robust.

In one embodiment, the convex envelope of the points of the I(V) curve is calculated by any method known for this purpose, for example by the Jarvis algorithm which is known to calculate the convex envelope of a finite set of points.

For example, the algorithm is set to the maximum voltage point (voltage V_{OC}). Next, the linear interpolation is tested with all points until the maximum current point (current I_{SC}) is selected.

In one embodiment, for all points considered, the voltage of all points with a voltage greater than V_{oc} is set to V_{oc} and all points with a current greater than I_{sc} are limited to I_{sc}.

Of course, any other alternative method of calculating the convex envelope is applicable.

The calculation of the parameters of the single-diode electrical model Wₜₕ is carried out in a similar way to that described with reference to step 48, with an optimisation of the model parameters according to the distance calculated in the polar coordinate system.

Then, the determination of the values of A_{d} and Aₗ is done in Cartesian coordinates (representation of current versus voltage), using the second model expressed by the formula [MATH 9].

Next, the second cost associated with the second approximation model is calculated (step 54) in polar coordinates, in order to produce a cost estimate that is consistent and comparable to the first cost calculated for the first approximation model.

At the end of step 54, the second cost D₂ is obtained, representative of the difference between the second approximation model ρ_{mod2}(φ) and the set of measurement points (ρᵢ, φᵢ) comprising J points, according to the chosen metric:

$${D}_{2} = {\sum }_{j = 1}^{J} {( {ρ}_{mod 2} ( {φ}_{j} ) - {ρ}_{j} )}^{2} \qquad [ MATH 10 ]$$

The method then comprises a step 56 of selecting an electrical model for estimating the I(V) curve from the first electrical approximation model and second electrical approximation model according to the first and second costs.

In one embodiment, the costs D1 and D2 are compared, and the electrical approximation model chosen is the one with the lowest cost.

Finally, the method comprises a step 58 of diagnosing operation and characterising, if necessary, a fault or anomaly in operation, depending on the parameters of the selected estimation model. If the selected estimation model is the first approximation model, the model parameters are analysed with respect to expected values of the model parameters, which are for example stored in a table of nominal parameter values.

For example, the expected values of the nominal parameters are defined in relation to temperature and radiation conditions, and/or are provided by the manufacturer or are calculated from an operating history.

In one embodiment, if certain parameter values of the selected estimation model deviate by more than a given threshold from the corresponding nominal parameter values, an anomaly is detected. For example, if the estimated series resistance Rₛ is higher by a given amount X than its expected value, X being for example between ⅓ and ⅔ of a “nominal” average value, an ageing of the connectors is detected.

Non-exhaustive examples of diagnosis according to the parameter values of the selected estimation model are given below.

The decrease of I_{sc} for a given irradiance indicates for example the presence of dirtiness or yellowing of the encapsulant of the photovoltaic modules, the encapsulation of the photovoltaic cells being a known method of protection of the cells of a photovoltaic module.

The drop in V_{oc} revealed a failure of a number of bypass diodes.

The decrease in Rₚ and/or the increase in N signals cell failures.

The simultaneous degradation of Rₛ, Rₚ, and N is generally indicative of Potential Induced Degradation, commonly referred to as PID, a known phenomenon causing a loss of efficiency in photovoltaic cells.

If the selected estimation model is the second approximation model, the presence of a mismatch is detected. The calculated parameters A_{d} and Aₗ allow to quantify the proportion of the chain affected by a drop in production and the proportion of drop in that subset.

The method further comprises a step 60 of displaying the diagnosis. For example, the display consists of lighting a light that forms a human-machine interface, indicating by its colour:

if the operation is normal, e.g. by a green light display,

if maintenance is required, e.g. by a yellow light display, or

if a malfunction is detected, e.g. by a red light display.

In addition, if the device for diagnosing operation has a display screen, details of the characteristics of the malfunctions found are displayed. In particular, the method can propose and display a numerical estimate of the associated production loss and provide a hypothesis on the nature of the problem encountered.

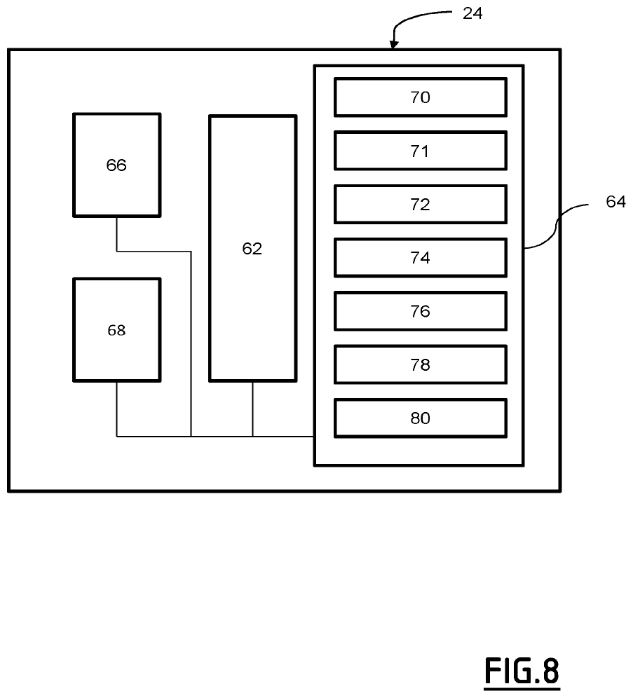

FIG. 8 is a schematic block diagram of a device for diagnosing operation 24 according to one embodiment.

The device for diagnosing operation is a programmable electronic device, comprising an electronic computing unit 62, consisting of one or more computing processors. The device 24 further comprises an electronic memory unit 64, and a human-machine interface 66. The human-machine interface includes, for example, a touch screen, or a screen and keyboard. Optionally, the device 24 further comprises a communication interface 68. The communication interface is, for example, a communication interface for radio communication with remote equipment, according to a radio communication protocol, for example WiFi, Bluetooth.

The elements 62, 64, 66, 68 are adapted to communicate with each other via a data communication bus.

The computing processor 62 is configured to execute modules implemented as software instructions to implement a method for diagnosing the operation of a photovoltaic module string comprising at least one photovoltaic module according to the invention.

These modules include:

a module 70 for acquiring a series of current and voltage measurements measured during a monitoring period of the at least one photovoltaic module, forming a current versus voltage curve;

a module 71 for estimating a short circuit current value I_{sc} and an open circuit voltage value V_{oc} from the acquired current and voltage values;

a module 72 for transforming into polar coordinates, each pair of current and voltage values of the I(V) curve being transformed into a corresponding radius-angle pair,

a module 74 for calculating parameters of a first electrical model approximating the I(V) curve, and a first cost representative of a deviation between the first model and the I(V) curve, by implementing a distance metric in polar coordinate space;

a module 76 for calculating parameters of a second electrical model approximating the I(V) curve, and a second cost representative of a deviation between the first model and the I(V) curve, by implementing a distance metric in polar coordinate space;

a module 78 for selecting an electrical model for estimating the I(V) curve from said first electrical approximation model and second electrical approximation model according to the first and second costs;

a module 80 for diagnosing operation as a function of the value of at least one parameter of the selected electrical estimation model.

In one embodiment, the modules 70, 71, 72, 74, 76, 78 and 80 are implemented as software instructions forming a computer program, which, when executed by a programmable electronic device, implements a method for diagnosing the operation of a photovoltaic module string comprising at least one photovoltaic module according to the invention.

In a variant not shown, the modules 70, 71, 72, 74, 76, 78 and 80 are each implemented in the form of programmable logical components, such as FPGAs (Field Programmable Gate Arrays), microprocessors, GPGPU components (General-Purpose computing on Graphics Processing Units), or dedicated integrated circuits, such as ASICs (Application-Specific Integrated Circuits).

The computer program comprising software instructions is further adapted to be recorded on a computer-readable, non-volatile information-recording medium. This computer-readable medium is, for example, a medium that can store electronic instructions and be coupled with a bus from a computer system. For example, this medium is an optical disk, magneto-optical disk, ROM memory, RAM memory, any type of non-volatile memory (for example EPROM, EEPROM, FLASH, NVRAM), magnetic card or optical card.

1. A method for diagnosing the operation of a string of photovoltaic modules comprising at least one photovoltaic module, the method comprising an acquisition of a series of current and voltage measurements measured during a monitoring period, forming a curve of current as a function of voltage, called the I(V) curve, comprising the steps, implemented by a computing processor, of:
transforming into polar coordinates, each pair of current and voltage values of the I(V) curve being transformed into a corresponding radius-angle pair,
calculating parameters of a first electrical model approximating said I(V) curve, and a first cost representative of a deviation between said first model and said I(V) curve, by implementing a distance metric in polar coordinate space,
calculating parameters of a second electrical model approximating said I(V) curve, and a second cost representative of a deviation between said second model and said I(V) curve, by implementing a distance metric in polar coordinate space,
selecting an electrical model for estimating the I(V) curve from said first electrical approximation model and second electrical approximation model according to the first and second costs,
diagnosing operation as a function of the value of at least one parameter of the selected electrical estimation model.

2. The method according to claim 1, further comprising a step of estimating a short-circuit current value and an open-circuit voltage value before the transformation into polar coordinates, corresponding respectively to extreme points of the I(V) curve, which are respectively a first point of voltage equal to zero and current equal to the short-circuit current value and a second point of voltage equal to the open circuit voltage value and current equal to zero, and wherein the polar coordinate transformation is normalised by said short circuit current and open circuit voltage values.

3. The method according to claim 2, wherein the transformation into normalized polar coordinates comprises, for each pair of current and voltage values, a division of the current value by said short circuit current value, and of the voltage value by said open circuit voltage value.

4. The method according to claim 3, wherein for a pair of measured values of current Iⱼ and voltage Vⱼ, the transformation into polar coordinates implements the following calculation to obtain a radius ρⱼ and a corresponding angle
$${ρ}_{j} = \sqrt{{( \frac{{I}_{j}}{{I}_{sc}} )}^{2} + {( \frac{{V}_{j}}{{V}_{oc}} )}^{2}} and {φ}_{j} = Arctan ( \frac{{I}_{j} \times {V}_{oc}}{{V}_{j} \times {I}_{sc}} )$$

5. The method according to claim 2, wherein the estimating of a short-circuit current value comprises:
calculating a power versus voltage characteristic from the current and voltage measurements,
modelling, in a first linear region of the power versus voltage characteristic, the power versus voltage characteristic by a first linear or polynomial power model, the short circuit current value being estimated by the zero derivative of said first power model.

6. The method according claim 2, wherein the estimating of an open circuit voltage value comprises:
calculating a power versus current characteristic from the current and voltage measurements,
modelling, in a second linear region of the power versus voltage characteristic, the power versus current characteristic by a second linear or polynomial power model, the open circuit voltage value being estimated by the zero derivative of said second power model.

7. The method according to claim 1, wherein the first electrical model for approximating said I(V) curve, is a so-called single-diode electrical model, defined by the following equation in polar coordinate space:
$${I}_{p h} + {I}_{0} - ρ ( φ ) \times \frac{cos ( φ ) + ( {R}_{s} + {R}_{p} ) \times sin ( φ )}{{R}_{p}} - {I}_{0} \times {e}^{ρ ( φ ) \times \frac{cos ( φ ) + {R}_{s} \times sin ( φ )}{N}} = 0$$
Where ρ(φ) is the radius corresponding to the angle φ according to the first approximation model, Iₚₕ, I₀, Rₛ, Rₚ and N are parameters of said first electrical model.

8. The method according to claim 1, further comprising determining a monitoring period duration for the acquisition of the current and voltage measurements, based on a previously stored table of monitoring period durations depending on physical characteristics of the photovoltaic module string comprising at least one photovoltaic module to be monitored.

9. The method according to claim 1, further comprising displaying a diagnostic result on a human-machine interface, indicating a state of good working order or a presence of an anomaly in the operation of said at least one photovoltaic module.

10. A device for diagnosing the operation of a string of photovoltaic modules comprising at least one photovoltaic module, adapted to obtain, from an acquisition module, a series of current and voltage measurements measured during a monitoring period, forming a curve of current as a function of voltage, known as the I(V) curve, the device comprising a computing processor configured to implement:
a module for transforming into polar coordinates, each pair of current and voltage values of the I(V) curve being transformed into a corresponding radius-angle pair,
a module for calculating parameters of a first electrical model approximating said I(V) curve, and a first cost representative of a deviation between said first model and said I(V) curve, by implementing a distance metric in polar coordinate space,
a module for calculating parameters of a second electrical model approximating said I(V) curve, and a second cost representative of a deviation between said second model and said I(V) curve, by implementing a distance metric in polar coordinate space,
a module for selecting an electrical model for estimating the I(V) curve from said first electrical approximation model and second electrical approximation model according to the first and second costs,
a module for diagnosing operation as a function of the value of at least one parameter of the selected electrical estimation model.

11. The device according to claim 10, further comprising a module for estimating a short circuit current value I_{sc} and an open circuit voltage value V_{oc} from the acquired current and voltage values.

12. A system for diagnosing the operation of a photovoltaic module string comprising at least one photovoltaic module, comprising a module for acquiring values of a series of current and voltage measurements measured during a monitoring period of at least one photovoltaic module of said photovoltaic module string, and a device for diagnosing operation according to claim 10.

13. A computer program having instructions including software instructions which, when executed by a programmable electronic device, implement a method of diagnosing the operation of a photovoltaic module string comprising at least one photovoltaic module according to claim 1.
